(19) United States
(12) Patent Application Publication
(10) Pub. No.: US 2020/0183376 A1
(43) Pub. Date: Jun. 11, 2020

(54) CONDUCTING A MAINTENANCE ACTIVITY ON AN ASSET

(71) Applicant: SUEZ WATER PTY LTD, Rhodes, New South Wales (AU)

(72) Inventor: Zoubir Ait Mansour, Rhodes, New South Wales (AU)

(21) Appl. No.: 15/781,641

(22) PCT Filed: Dec. 22, 2016
(86) PCT No.: PCT/AU2016/051270

§ 371 Date: Jun. 5, 2018

(30) Foreign Application Priority Data
Dec. 23, 2015 (AU) 2015905372

(51) Int. Cl. G05B 23/02; G06Q 10/00

(52) U.S. Cl. CPC G05B 23/0283; G06Q 10/20

(57) ABSTRACT

A computer-implemented method (200) for conducting a maintenance activity on an asset, comprising: obtaining (202) a value of a first parameter, the value of the first parameter being indicative of a first operation risk level of the asset over time with respect to a failure mode of the asset without a first conduct of the maintenance activity; obtaining (204) values of a set of parameters indicative of properties of the maintenance activity with respect to the failure mode of the asset; determining (206) a time interval between the first conduct of the maintenance activity and a second conduct of the maintenance activity based on a model, the model containing the value of the first parameter and the values of the set of parameters, and the model representing a value of a second parameter indicative of an average operation risk level of the asset over the time interval with respect to the failure mode of the asset given the first conduct of the maintenance activity and the second conduct of the maintenance activity; and if (208) the average operation risk level indicated by the value of the second parameter is lower than the first operation risk level indicated by the value of the first parameter, causing (210) the second conduct of the maintenance activity to be performed.

### TECHNICAL FIELD

The present disclosure generally relates to asset maintenance methods and devices. The present disclosure includes computer-implemented methods, software, computer systems for conducting a maintenance activity on an asset.

### BACKGROUND

An organisation provides certain types of service by operating one or more assets. For example, the organisation may be a water treatment company that operates one or more water treatment factories, which include a variety of water treatment-related equipment for example, pumps, pipes, motors, water tanks, to provide water treatment services to the community. These factories or equipment may be referred to as assets operated by the organisation (i.e., water treatment company in this example). The manufacturers of the assets usually provide the organisation with user manuals to conduct maintenance activities on the assets operated by the organisation in order to keep the workability of the assets at a reasonable level. For example, a user manual for a pump in a water treatment factory may provide that the pump should be cleaned every three months or lubricated every 12 months. However, such a maintenance interval is based on an empirical estimate, which may not achieve the best result. For example, the maintenance activities based on such a maintenance interval may be too frequent, which results in a waste of resources spent on the maintenance activities, or too infrequent, this results in lack of maintenance on the asset.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present disclosure is not to be taken as an admission that any or all of these matters form part of the prior art base or were common general knowledge in the field relevant to the present disclosure as it existed before the priority date of each claim of this application.

### SUMMARY

There is provided a computer-implemented method for conducting a maintenance activity on an asset, comprising:
obtaining a value of a first parameter, the value of the first parameter being indicative of a first operation risk level of the asset over time with respect to a failure mode of the asset without a first conduct of the maintenance activity;
obtaining values of a set of parameters indicative of properties of the maintenance activity with respect to the failure mode of the asset;
determining a time interval between the first conduct of the maintenance activity and a second conduct of the maintenance activity based on a model, the model containing the value of the first parameter and the values of the set of parameters, and the model representing a value of a second parameter indicative of an average operation risk level of the asset over the time interval with respect to the failure mode of the asset given the first conduct of the maintenance activity and the second conduct of the maintenance activity; and
if the average operation risk level indicated by the value of the second parameter is lower than the first operation risk level indicated by the value of the first parameter, causing the second conduct of the maintenance activity to be performed.

It is an advantage that by causing the second conduct of the maintenance to be performed only when the second conduct of the maintenance activity produces an average operation risk level lower than the first operation risk level, the time interval determined according to the present disclosure ensures that the resource consumption by the asset resulting from the first conduct of the maintenance activity and the second conduct of the maintenance activity is lower than the resource consumption without any maintenance activities conducted.

Determining the time interval may further comprise determining the time interval such that the value of the second parameter is minimised.

Causing the second conduct of the maintenance activity to be performed may comprise:
sending the time interval to a Computerized Maintenance Management System (CMMS) to cause the second conduct of the maintenance activity to be performed at the time interval after the first conduct of the maintenance activity is performed.

Causing the second conduct of the maintenance activity to be performed may comprise:
generating a maintenance schedule containing the time interval;
send the maintenance schedule to a maintenance mechanism associated with the asset, wherein the maintenance mechanism is configured to automatically perform the maintenance activity based on the maintenance schedule.

The method may further comprise:
sending a maintenance notification message including the maintenance schedule to a mobile device, the maintenance notification message causing the maintenance schedule to be displayed on the mobile device.

Obtaining the values of the set of parameters may comprise determining the values of the set of the parameters indicative of one or more of the following properties of the maintenance activity:
a level of an effect of the maintenance activity on the first operation risk level;
a duration of the maintenance activity;
a cost level of the maintenance activity; and
a fading mode of the effect of the maintenance activity on the first operation risk level.

Obtaining the value of the first parameter may comprise determining a failure frequency of the failure mode and a severity level of the failure mode to determine the value of the first parameter.

Determining the failure frequency of the failure mode may comprise determining an average failure frequency based on occurrences of the failure mode in a past period of time.

Determining the severity level of the failure mode may comprise determining the severity level based on impact levels indicative of impacts of the failure mode on one or more of following aspects:
production, troubleshooting, safety, environment, and reputation.

Determining the severity level of the failure mode may comprise calculating a sum of the impact levels.

Determining the value of the first parameter may comprise calculating a product of the sum of the impact levels of the failure mode and the average failure frequency of the failure mode.

The method may further comprise determining an operation criticality rank based on the value of the first parameter.

The method may further comprise:
receiving first data indicative of the first operation risk level of the asset from a Supervisory Control and Data Acquisition (SCADA) system;
receiving second data indicative of the properties of the maintenance activity from a user interface;
updating the value of the first parameter based on the first data; and updating one or more of the values of the set of the parameters based on the second data.

There is provided a computer software program, including machine-readable instructions, when executed by a processor, causes the processor to perform the method described herein.

There is provided a computer system for conducting a maintenance activity on an asset, the computer system comprising:
a first communication interface configured to interface with a Supervisory Control and Data Acquisition (SCADA) system;
a second communication interface configured to interface with a parameter calibration database; and
a processor configured to:
   obtain a value of a first parameter from the SCADA system, via the first communication interface, the value of the first parameter being indicative of a first operation risk level of the asset over time with respect to a failure mode of the asset without a first conduct of the maintenance activity;
   obtain values of a set of parameters from the parameter calibration database, via the second communication interface, the values of the set of parameters indicative of properties of the maintenance activity with respect to the failure mode of the asset; and
   determine a time interval between the first conduct of the maintenance activity and a second conduct of the maintenance activity based on a model, the model containing the value of the first parameter and the values of the set of parameters and the model representing a value of a second parameter indicative of an average operation risk level of the asset over the time interval with respect to the failure mode of the asset given the first conduct of the maintenance activity and the second conduct of the maintenance activity; and
   if the average operation risk level indicated by the value of the second parameter is lower than the first operation risk level indicated by the value of the first parameter, cause the second conduct of the maintenance activity to be performed.

The processor may be further configured to determine the time interval such that the value of the second parameter is minimised.

The computer system may further comprise a third communication interface configured to interface with a Computerized Maintenance Management System (CMMS), and the processor is further configured to
send the time interval to the CMMS, via the third communication interface, to cause the second conduct of the maintenance activity to be performed at the time interval after the first conduct of the maintenance activity is performed.

There is also provided a computer-implemented method for conducting a maintenance activity on an asset, comprising the steps of:
a first step of obtaining input parameters, the input parameters being at least
a value of a risk to failure (R) over time t;
a value of a reduction of risk (RR) over time t, the reduction of risk being result of the implementation of an action (A);
a period of time (P) in which the value of the reduction of risk (RR) is maintained result of the implementation of the action (A);
a second step of determining a period of time between actions (PA) in such a way that a new risk to failure (NRF) over time is minimized, the new risk to failure (NRF) taking into account the input parameters, the time t and a cost (C) of performing the action (A).

In an example of the computer-implemented method, the input parameters further comprise a value of the cost (C) of implementing the action (A).

Advantageously, the method may allow determining a period of time between actions (PA) and may allow performing an action (A) after said period of time between actions (PA) only if the new risk to failure (NRF) is lower than a threshold. It may be an advantage that by causing the action (A) to be performed only when a new risk to failure (NRF) is lower than the predetermined threshold, the resource consumption resulting from the action (A) is lower than the resource consumption without any maintenance activities conducted.

The computer-implemented method may further comprise:
a third step of calculating a gain (G) associated with implementing the action (A) and
a fourth step of discriminating whether the action (A) is to be implemented as a function of a comparison between the gain (G) with a predetermined threshold.

If the action is to be implemented, the computer implemented method may cause the action (A) to be performed. Causing the action (A) activity to be performed may comprise sending a period of time between actions (PA) to a computerized Maintenance Management System (CMMS) to cause the action (A) activity to be performed at a period of time between actions (PA) after a first conduct of the action (A) or maintenance activity to be performed.

In one example, obtaining in a value of a risk to failure (R) over time t comprises determining a failure frequency based on occurrences of failure in a past period of time.

In one example, a decrease of value of a reduction of risk (RR) over time t, indicates a reduction in troubleshooting and/or safety and/or environment and/or reputation.

In another example, the computer-implemented method further comprises determining a relevance level based on the value of the value of a risk to failure.

In one example, the step of obtaining a value of a risk to failure (R) over time t comprises receiving the value of a risk to failure (R) from a Supervisory Control and Data Acquisition, or SCADA system.

In one example, the step of obtaining a value of a reduction of risk (RR) over time t comprises receiving the value of a reduction of risk (RR) from a user interface;

In one example, the step of obtaining a period of time (P) in which the value of the reduction of risk (RR) is maintained result of the implementation of the action (A) comprises receiving the period of time (P) from a user interface.

In one example, the steps of the method are periodically implemented and the values of the input parameters are updated at each implementation.

Obtaining the values of the input parameters may comprise determining the values of the set of the parameters indicative of one or more of the following properties of the maintenance activity:
a level of an impact of the maintenance activity on the predetermined threshold;
a duration of the maintenance activity;
a cost level of the maintenance activity; and
a fading mode of the impact of the maintenance activity on the predetermined threshold.

In the context of the present specification an impact means the value of a reduction of risk (RR) over time t, the reduction of risk being result of the implementation of an action (A).

Obtaining the value of the value of a risk to failure may comprise determining a failure frequency of the failure and a value of a reduction of risk of the failure to determine the value of the value of a risk to failure.

Determining the value of a reduction of risk of the failure may comprise calculating a sum of the impact levels.

Determining the value of the value of a risk to failure may comprise calculating a product of the sum of the impact levels of the failure and the average failure frequency of the failure.

The method may further comprise:
receiving risk to failure (RF) indicative of the predetermined threshold of the asset from a Supervisory Control and Data Acquisition (SCADA) system;
receiving second data indicative of the properties of the maintenance activity from a user interface;
updating the value of the value of a risk to failure based on the risk to failure (RF); and
updating one or more of the values of the set of the parameters based on the second data.

There is provided a computer system for conducting a maintenance activity on an asset, the computer system comprising:
means for obtaining a value of a risk to failure (R) over time t, for example a SCADA system;
means for obtaining a value of a reduction of risk (RR) over time t, the reduction of risk being result of the implementation of an action (A), for example a user interface;
means for obtaining a period of time (P) for example a user interface;
means for determining a period of time between actions (PA) in such a way that a new risk to failure (NRF) over time is minimized, the new risk to failure (NRF) taking into account the input parameters, the time t and a cost (C) of performing the action (A), for example a microprocessor.

In one example, the computer system may comprise:
a first communication interface configured to interface with a Supervisory Control and Data Acquisition (SCADA) system;
a second communication interface configured to interface with a parameter calibration database; and
a processor configured to:
   obtain a value of a value of a risk to failure from the SCADA system, via the first communication interface, the value of the value of a risk to failure being indicative of a predetermined threshold of the asset over time with respect to a failure of the asset without a first conduct of the maintenance activity;
   obtain values of a set of parameters from the parameter calibration database, via the second communication interface, the values of the set of parameters indicative of properties of the maintenance activity with respect to the failure of the asset; and
   determine a time interval between the first conduct of the maintenance activity and an action (A) activity based on a model, the model containing the value of the value of a risk to failure and the values of the set of parameters and the model representing a value of a new risk to failure (NRF) indicative of an average operation risk level of the asset over a period of time between actions (PA) with respect to the failure of the asset given the first conduct of the maintenance activity and the action (A) activity; and
   if the average operation risk level indicated by the value of the new risk to failure (NRF) is lower than the predetermined threshold indicated by the value of the value of a risk to failure, cause the action (A) activity to be performed.

The processor may be further configured to determine a period of time between actions (PA) such that the value of the new risk to failure (NRF) is minimised.

The computer system may further comprise a third communication interface configured to interface with a Computerized Maintenance Management System (CMMS), and the processor is further configured to
send a period of time between actions (PA) to the CMMS, via the third communication interface, to cause the action (A) activity to be performed at a period of time between actions (PA) after the first conduct of the maintenance activity is performed.

### BRIEF DESCRIPTION OF DRAWINGS

Features of the present disclosure are illustrated by way of non-limiting examples, and like numerals indicate like elements, in which:

FIG. 1 illustrates an example asset management system in accordance with the present disclosure;

FIG. 2 illustrates a computer-implemented method for conducting a maintenance activity on an asset in accordance with the present disclosure;

FIG. 3 illustrates an example model used in the present disclosure to determine the time interval for maintenance activities in accordance with the present disclosure;

FIG. 4 illustrates an example asset record associated with an asset in accordance with the present disclosure; and

FIG. 5 illustrates an example computer system for conducting a maintenance activity on an asset in accordance with the present disclosure.

### DESCRIPTION OF EMBODIMENTS

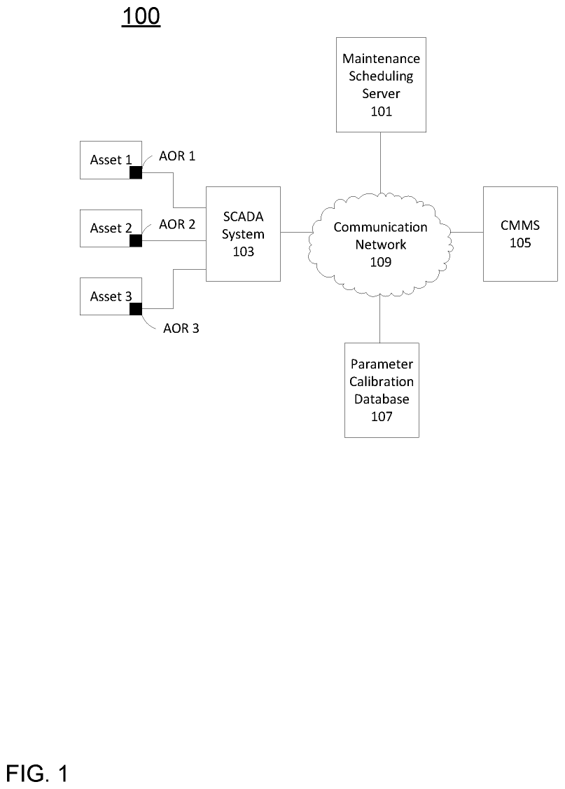

FIG. 1 illustrates an example asset management system 100 in accordance with the present disclosure.

The asset management system 100 includes a maintenance scheduling server 101, a Supervisory Control and Data Acquisition (SCADA) system 103, a Computerized Maintenance Management System (CMMS) 105, a parameter calibration database 107, and a communication network 109. The asset management system 100 manages operation of assets 1, 2, 3.

The SCADA system 103 includes one or more asset operation recorders (referred to as “AOR”) 1, 2, 3 that are connected to the assets 1, 2, 3 mechanically or electrically. The AORs 1, 2, 3 record operation statuses of the assets 1, 2, 3.

The assets 1, 2, 3 can be pumps, motors, or other components that are operated by an organisation. The asset management system 100 schedules troubleshooting activities when one or more of the assets 1, 2, 3 is not working normally, or schedules maintenance activities to maintain the assets 1, 2, 3 in normal working conditions as long as possible between troubleshooting activities.

In one example, the system 100 may perform a computer-implemented method for conducting a maintenance activity on an asset, the method comprises:
obtaining a value of a value of a risk to failure, the value of the value of a risk to failure being indicative of a predetermined threshold of the asset over time with respect to a failure of the asset without a first conduct of the maintenance activity;
obtaining values of a set of parameters indicative of properties of the maintenance activity with respect to the failure of the asset;
determining a time interval between the first conduct of the maintenance activity and an action (A) activity based on a model, the model containing the value of the value of a risk to failure and the values of the set of parameters, and the model representing a value of a new risk to failure (NRF) indicative of an average operation risk level of the asset over a period of time between actions (PA) with respect to the failure of the asset given the first conduct of the maintenance activity and the action (A) activity; and
if the average operation risk level indicated by the value of the new risk to failure (NRF) is lower than the predetermined threshold indicated by the value of the value of a risk to failure, causing the action (A) activity to be performed.

An example troubleshooting process is described below.

Take asset 1 as an example. If asset 1 stops working, in other words, loses its functionalities, the AOR 1 connected to asset 1 records data in relation to the function lost event associated with asset 1, which is also referred to as event data in this present disclosure. The event data may indicate when this event happens to asset 1, how long the function lost status lasts, when asset 1 returns to the normal working condition after a troubleshooting activity, etc.

The AOR 1 transmits the event data to the SCADA system 103. The SCADA system 103 receives the event data associated with asset 1 from the AOR 1 and transmits the event data to the CMMS 105 over the communication network 109.

The CMMS 105 generates a troubleshooting schedule (such as a work request) based on the event data received from the SCADA system 103. The CMMS 105 sends the troubleshooting schedule to an account to which a technician has access, for example, an email account (for example, an email address), an mobile account (for example, a mobile phone number) of the technician. As a result, the technician is able to be aware of the fact that asset 1 has lost its functions and it is necessary to take appropriate actions to bring asset 1 back to normal working conditions by fixing problems that cause asset 1 to stop working.

A maintenance process is described below.

The maintenance scheduling server 101 generates maintenance information to conduct maintenance activities (for example, cleaning or lubricating asset 1 at a time interval) with the hope of keeping asset 1 in normal working conditions as long as possible between troubleshooting schedules. The maintenance scheduling server 101 sends the maintenance information to the CMMS 105 over the communication network 109. The CMMS 105 generates a maintenance schedule based on the maintenance information received from the maintenance scheduling server 101, and sends the maintenance schedule to the technician to conduct the maintenance activities according to the maintenance schedule.

The maintenance schedule contains the maintenance information in relation to the maintenance activities to be conducted. For example, the maintenance information indicates one or more of the following: the time interval between maintenance activities, when to conduct the maintenance activities, what maintenance activities need to be conducted, who will conduct the maintenance activities, which asset(s) needs to be maintained, and time and/or financial costs associated with maintenance activities, etc.

The maintenance schedule may be generated in different ways. An example of a way is to generate the maintenance schedule for asset 1 based on the instructions given in the operation manual of asset 1, for example, cleaning every three months. However, as described above, such an empirical maintenance schedule may not achieve the best result.

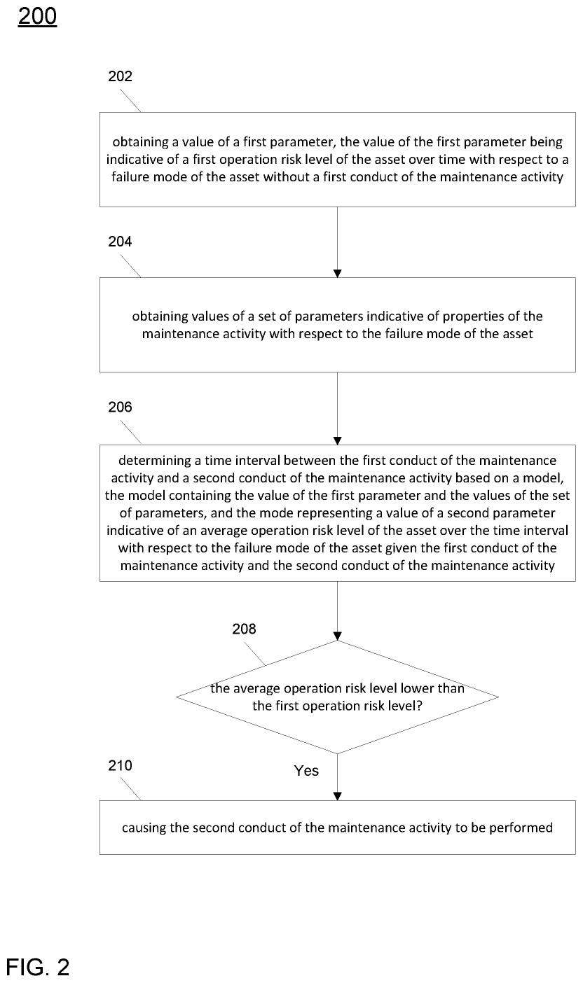

FIG. 2 illustrates a computer-implemented method 200 for conducting a maintenance activity on an asset in accordance with the present disclosure. Although the method 200 is described below with reference to asset 1, the method 200 is also applicable to other assets 2 and 3. The method 200 is performed at the maintenance scheduling server 101 in this example, but the method 200 can be performed at the SCADA system 103 and/or the CMMS 105 without departing from the scope of the present disclosure.

In some examples, asset 1 operates at different operation risk levels over time. For example, if asset 1 is a brand new asset, it may need less maintenance, while if asset 1 has been operating for a long time, more frequent maintenance may be needed to keep asset 1 in normal working conditions between troubleshooting schedules. The method 200 takes into account operation risk of asset 1 when determining when to conduct maintenance activities on asset 1, for example, the time interval between maintenance activities. In some examples, the time interval may be a period of time between actions (PA).

In the present disclosure, the operation risk of asset 1 is quantified to indicate an operation risk level of asset 1 over time. Specifically, an “operation risk level without maintenance” parameter (referred to as a first parameter or a value of a risk to failure) is used to indicate the operation risk level (referred to a first operation risk level which in some examples may be a predetermined threshold) of asset 1 over time without any maintenance activities conducted. It should be noted that this does not mean that the method 200 is only applicable to a brand new asset; instead, the first operation risk level (or predetermined threshold) in the present disclosure refers to the operation risk prior to application of the method 200 to the asset. Therefore, the method 200 is also applicable to an asset that has been operated or maintained according to other maintenance schedules (for example, the maintenance schedule as suggested by the manufacturer of the asset).

Specifically, the value of the first parameter (value of a risk to failure) for asset 1 reflects an operation risk level resulting from a failure mode (for example, function lost) of asset 1 without a first conduct of the maintenance activity.

The operation risk level of an asset is represented by an amount of resource consumed by an organisation to keep the asset operational. The resources that are involved in operating the asset can take a variety of forms, including energy consumption (for example, fuel, electricity), human resources (for example, man-hours), auxiliary tools or materials, spare parts, organisation reputation, safety, environment, production, maintenance, and troubleshooting, etc. Since these resources are measured by different measurement units, this makes it hard to consider these resources in a consolidated way when representing the operation risk level of the asset.

In the present disclosure, the amount of resource is measured by a common measurement unit regardless of the form of the resource. For example, a dollar ($) value that indicates how much the amount of resource is worth can be used to measure the amount of resource. An example value of the first parameter (or value of a risk to failure referred to as “R”) is 40 dollars/day, which represents the operation resource consumed by asset 1 is worth 40 dollars every day prior to the first conduct of the maintenance activity. Under this measurement system, a larger amount of resource consumed by the organisation to operate the asset represents a higher operation risk level of the asset. The operation risk level can be represented in other ways without departing from the scope of the present disclosure.

In the present disclosure, the first parameter (value of a risk to failure) R=average failure frequency of failure x average severity level (e.g. value of a reduction of risk that may also be expressed in dollars in the present disclosure for description purposes).

For example, if asset 1 has one failure every two years, which consumes $10,000 worth of operation resource (including troubleshooting, production loss, safety, environmental and reputation impacts), then

average failure frequency of failure mode=1/(2×365) (occurrence/day)

average severity level=10,000/1=10,000 (dollars/occurrence)

R=1/(2×365)×10,000=13.7 (dollars/day)

In the present disclosure, a set of parameters are used to indicate properties of the maintenance activity with respect to the failure mode of the asset. The properties of the maintenance activity includes a level of an effect of the maintenance activity (e.g. impact of the maintenance activity) on the first operation risk level (predetermined threshold), a duration of the maintenance activity, a cost level of the maintenance activity, and a fading mode of the effect of the maintenance activity on the first operation risk level (predetermined threshold).

The level (referred to as “i”) of an effect of the maintenance activity on the first operation risk level (predetermined threshold) may be measured by a percentage representing how much the first operation risk level (predetermined threshold) is reduced immediately following the first conduct of the maintenance activity. For example, if the first operation risk level (predetermined threshold) is reduced to 20 dollars/day from 40 dollars/day immediately following the first conduct of the maintenance activity, then i=50%.

The duration of the maintenance activity (referred to as “e”) represents a time span (for example, in days) during which the maintenance activity are effective. That is, the duration of the maintenance activity means how long it takes for operation risk level to restore to the first operation risk level (predetermined threshold) after the first conduct of the maintenance activity. This represents a maximal time interval at which the maintenance activity is to be conducted. For example, the effect of adjusting the tension of a fan may last 30 days.

The cost level of the maintenance activity (referred to as “c”) represents an average cost for conducting the maintenance activity (for example, in dollars).

The fading mode of the effect of the maintenance activity on the first operation risk level (predetermined threshold) represents how the effect of the maintenance activity disappears over time, in other words, how the operation risk level (predetermined threshold) of asset 1 after the first conduct of the maintenance activity restores over time to the first operation risk level if no further conduct of the maintenance activity is performed. In this example, the operation risk level of asset 1 after the first conduct of the maintenance activity restores to the first operation risk level (predetermined threshold) over time in a linear manner. In other examples, the operation risk level may restore to the first operation risk level (predetermined threshold) over time in other manners without departing from the scope of the present disclosure.

The method 200 obtains 202 the value of the first parameter (value of a risk to failure) and obtains 204 the values of the set of the parameters indicative of the properties of the maintenance activity.

The method 200 determines 206 a time interval between the first conduct of the maintenance activity and a second conduct of the maintenance activity (e.g. an action (A) activity) based on a model. In the present disclosure, the model contains the value of the first parameter (e.g. value of a risk to failure) and the values of the set of parameters, and represents a value of a second parameter (e.g. new risk to failure (NRF)) indicative of an average operation risk level of asset 1 over the time interval (e.g. a period of time between actions (PA) that may be between first conduct of the maintenance activity and the second conduct of the maintenance activity/action (A) activity) with respect to the failure mode of asset 1 given the first conduct of the maintenance activity and the second conduct of the maintenance activity (e.g. the action (A) activity).

The method 200 determines 208 if the average operation risk level indicated by the value of the second parameter (e.g. new risk to failure (NRF)) is lower than the first operation risk level (e.g. predetermined threshold) indicated by the value of the first parameter (e.g. value of a risk to failure). If the average operation risk level is lower than the first operation risk level (predetermined threshold), the method 200 causes 210 the second conduct of the maintenance activity (action (A) activity) to be performed.

As can be seen from the above, the method 200 causes the second conduct of the maintenance activity (action (A) activity) to be performed only when the second conduct of the maintenance activity (action (A) activity) produces an average operation risk lever lower than the first operation risk level (predetermined threshold). This means the time interval (e.g. period of time between actions (PA)) determined according to the method 200 ensures that the resource consumption by asset 1 resulting from the first conduct of the maintenance activity and the second conduct of the maintenance activity (action (A) activity) is lower than the resource consumption without any maintenance activities conducted.

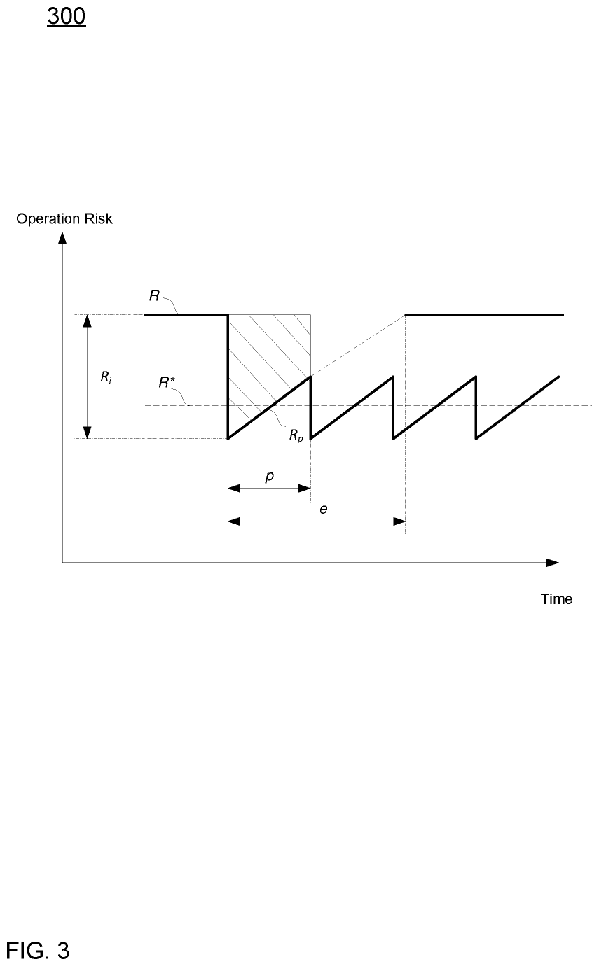

FIG. 3 illustrates an example model used in the present disclosure to determine the time interval (period of time between actions (PA)) for maintenance activities.

In FIG. 3, the horizontal axis represents time, and the vertical axis represents the operation risk level over time. p represents the time interval (period of timer between actions (PA)) between the first conduct of the maintenance activity and the second conduct of the maintenance activity (action (A) activity). Rᵢ represents an operation risk level reduction that is achieved immediately after the first conduct of the maintenance activity Rᵢ=R×i.

R* is the second parameter (new risk to failure (NRF)) indicating the average operation risk level between the first conduct of the maintenance activity and the second conduct of the maintenance activity (action (A) activity). This means the resources consumed by asset 1 at a constant rate of R* between the first conduct of the maintenance activity and the second conduct of the maintenance activity (action (A) activity) is the same as the resources consumed by asset 1 in the way indicated by the fading mode. In this example, since the fading mode is a linear mode, as shown by the straight line segment Rₚ in FIG. 3, the average operation risk level R* (i.e., the second parameter or new risk to failure (NRF)) is determined as below:

$${R}^{*} = R \cdot ( 1 - i ) + \frac{{R}_{i} \cdot p}{2 e} + \frac{c}{p} \qquad ( 1 )$$

It should be noted that R* may take different forms depending on the fading mode of the effect of the maintenance activity.

The benefit or gain G resulting from the above model is represented by

$$G = R - {R}^{*} = R \cdot i - \frac{{R}_{i} \cdot p}{2 e} - \frac{c}{p} \qquad ( 2 )$$

Theoretically, there may be more than one time intervals (p) that make G greater than zero, which means the average operation risk level R* (e.g., the second parameter or new risk to failure (NRF)) is lower than the first operation risk level (predetermined threshold R (indicated by the first parameter or value of a risk to failure). To maximise the benefit resulting from the present disclosure, the method 200 further determines a time interval such that the average operation risk level R* is minimised. Specifically, the method 200 determines a derivative of R* (see equation (1)) with respect top, and let the derivative be zero as below:

$$\begin{matrix}\frac{{dR}^{*}}{dp} = 0 & ( 3 ) \\ \frac{{R}_{i}}{2 e} - \frac{c}{{p}^{2}} = 0 & ( 4 )\end{matrix}$$

Therefore, the optimal time interval pₒₚₜ that causes the derivative of the average operation risk level R* to be zero is determined as below

$${p}_{opt} = \sqrt{\frac{2 e \cdot c}{R \cdot i}} \qquad ( 5 )$$

Given the optimal time interval pₒₚₜ, if the resulting benefit G is greater than zero, the method 200 causes the second conduct of the maintenance activity (action (A) activity) to be performed. Once the time intervals (e.g. period of time between actions (PA)s) for one or more of assets 1, 2, 3 are determined as above, the maintenance scheduling server 101 sends the time intervals (the period of time between actions (PA)s) to the CMMS 105 over the communication network 109. Upon receipt of the time intervals (period of time between actions (PA)s), the CMMS 105 generates a maintenance schedule. As described above, the maintenance schedule contains the time intervals (the period of time between actions (PA)s). The CMMS 105 sends the maintenance schedule to one or more technicians for them to conduct the maintenance activities on one or more of assets 1, 2, 3 according to the maintenance activities.

In another example, the maintenance schedule is displayed on a display for technicians to view in order to perform the maintenance activities according to the maintenance schedule.

In another example, the maintenance schedule containing the time interval (period of time between actions (PA)s) may be generated by the maintenance scheduling sever 101. The maintenance schedule is sent to a maintenance mechanism associated with the asset. Particularly, the maintenance mechanism (for example, a robot) may be mechanically and/or electrically connected to the asset. The maintenance mechanism is configured to automatically perform the maintenance activities based on the maintenance schedule.

In another example, the maintenance scheduling sever 101 sends a maintenance notification message to a mobile device of a technician at a notification time that is based on the maintenance schedule, such as one day before the scheduled maintenance. The maintenance notification message includes the maintenance schedule and causes the maintenance schedule to be displayed on the technician's mobile device. The maintenance notification message comprises a link that allows the technician to access details of this particular maintenance activity stored on the CMMS 105. This way, the maintenance scheduling sever 101 informs the technician timely such that the maintenance activity can be performed as scheduled. The link in the maintenance notification message also allows the technician to enter data documenting the completion of the maintenance activity. For example, the technician may activate a camera to capture a photo of the asset before and after the maintenance activity and enter the date and details of the performed maintenance activity.

The determination of the value of the first parameter (value of a risk to failure) R is described in detail below. As described above, the value of the first parameter (value of a risk to failure) R is the product of an average failure frequency of a failure mode and an average severity level of the failure mode.

The method 200 may determine the average failure frequency and the average severity level (value of a reduction of risk) in relation to a failure mode in different ways. For example, the method 200 may receive the average failure frequency and the average severity level (value of a reduction of risk) from the parameter calibration database 107, and calculates the value of the first parameter (value of a risk to failure) R based on the received average failure frequency and average severity level (value of a reduction of risk).

In another example, the method 200 can determine the average failure frequency and the average severity level (value of a reduction of risk) from historical failure data. The historical failure data may be received from the SCADA system 103. The historical failure data contain occurrences of the failure mode in a past period of time. Particularly, the method 200 determines the average failure frequency by dividing the number of occurrences by the number of days in the past period of time.

In a further example, if a probability (likelihood) of the failure mode is known, the probability may be used to determine the average failure frequency of the failure mode.

The severity level (value of a reduction of risk) of the failure mode is reflected by resources that are consumed to mitigate or remove the impact of the failure mode on one or more aspects including (but not limited to): production, troubleshooting, safety, environment, and reputation. Therefore, the method 200 determines the severity level (value of a reduction of risk) based on impact levels indicative of impacts of the failure mode on these aspects. To be consistent with the representation of the first operation risk level (predetermined threshold) R (indicated by the first parameter or value of a risk to failure) in the unit of dollar/day, the impact levels are represented by a number in the unit of dollar/day in this example. However, the impact level may be represented in other ways without departing from the scope of the present disclosure. The impact levels on different aspects are described below.

### Impact on Production

A same failure mode can have different impacts if a wastewater treatment plant (WWTP) operates at a full capacity or at 30% of the full capacity (e.g. storm or dry weather for a WWTP). Assuming in this example that asset 1 (for example, a pipe) operates in a context of yearly average flow. A multi-context analysis can be performed in other examples, in which a same failure mode is taken into account in different contexts of operation.

If a failure mode occurs, the failure mode may result in water that is not in compliance with hygiene standard. The water is considered to be untreated water. The volume of the untreated water due to the failure mode is estimated based on the flow rate (yearly average) of asset 1 (for example, a pipe) and the mean time spent in bringing asset 1 back to normal working conditions under which the WWTP is able to produce water in compliance with hygiene standard. Since the WWTP obtains an income from the community for processing wastewater. If the wastewater is not processed properly; it is considered that the WWTP does not deserve the income associated with the volume of the untreated water. Consequently, the method 200 may use a cost of per hour of untreated wastewater, corresponding to the yearly average revenue divided by 8760 hour/year.

In case of a water delivery interruption affecting the final customer, the method 200 may use a severity weight corresponding to the estimated average selling price per m³, converted in dollar/hour based on average flow.

In case of a water delivery interruption without an impact on the final customer, the method 200 may use a severity weight corresponding to the estimated average production cost.

In case of a planned water delivery interruption without an impact on the final customer, the method 200 may use a severity weight corresponding to 50% of the estimated average production cost.

In case of an impact on energy consumption or energy production, the method 200 may use an energy cost per kWh. The yearly energy consumption of the WWTP can be used for estimating the energy impacts.

The method 200 may use the cost of yearly consumption of a reagent by the WWTP to estimate an impact of the failure mode on chemical consumption.

The method 200 may use a minor operational inconvenience cost per hour to reflect variable severity in case of minor inconvenience, minor energy or reagent consumption.

The method 200 may use a severity weight for the loss of a sludge line. The severity weight of the sludge line is estimated based on impacts on energy consumption (e.g. more aeration required if sludge extraction is stopped and concentration increases), reagents, trucks, final treatment cost, etc.

### Impact on Troubleshooting

The method 200 may use a labour cost per man-hour. For example, a 33% additional cost can be added to reflect coordination and management time. For instance, if the average direct cost of a technician is 45 dollars per man-hour, then 60 dollars per man-hour is determined by the method 200 to address each occurrence of the failure mode.

The method 200 may take into account spare parts availability assumption that is based on the most realistic current scenario for the considered asset failure mode. The average costs of spare parts may be stored in the parameter calibration database 107 and can be updated by a system operator.

### Impact on Environment

Each occurrence of the failure mode may incur an environmental cost. Depending on the severity of the failure mode, the environmental cost can be $5k per occurrence, $30k per occurrence, or even $100k per occurrence. The environmental cost of the failure mode may be stored in the parameter calibration database 107.

### Impact on Safety

The main safety risk exposure is experienced by the technicians during a troubleshooting process for recovering the asset function from an occurrence of the failure mode. Therefore, the impact on safety is associated with the number of man-hours required for addressing the occurrence of the failure mode. For example, $10/h corresponds to 25 accidents per million man-hours with a moral cost of $400k per accident.

When required, an additional safety impact can be taken into account (e.g., chlorine leakage=$30k; explosion=$5 million, etc.)

### Impact on Reputation

The impact on reputation may be modelled as a separate criterion or included in production (customer service delivery interruption) or environment (odour control issues. Additionally, the cost per person affected can be used to quantify the impact on reputation.

Once the impact levels on the aspects described above are determined, the method 200 calculates a sum of the impact levels to determine the severity level (value of a reduction of risk) of failure mode.

The method 200 determines the value of the first parameter (value of a risk to failure) R (indicating the first operation risk level or predetermined threshold) by calculating a product of the sum of the impact levels (i.e., the severity level/value of a reduction of risk of failure) and the average failure frequency of the failure mode.

The method 200 can further determine an operation criticality rank (e.g. a relevant level) based on the value of the first parameter (e.g. value of a risk to failure). The operation criticality rank (e.g. relevance level) may be represented by numbers 1 to 100 with the highest criticality rank being one. The operation criticality rank (relevance level) may also be represented by text description, for example, “high risk, immediate attention needed”, “medium risk, inspection needed”, “low risk, no action needed”, etc. The operation criticality rank (relevance level) is sent from the maintenance scheduling server 101 to CMMS 105 over the communication network 109. The CMMS 105 sends the operation criticality rank (relevance level) to a technician for the technician to take actions accordingly.

In the present disclosure, each of assets 1, 2, 3 has an asset record stored in the parameter calibration database 107, the asset record associated with the asset contains information that is used to determine if a maintenance activity on the asset needs to be conducted.

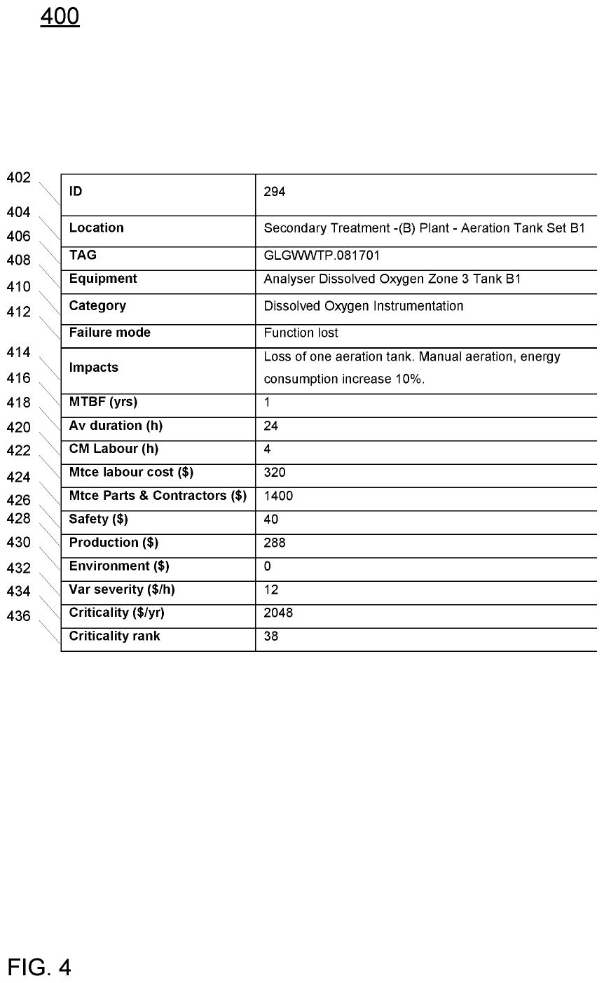

FIG. 4 illustrates an example asset record 400 associated with an asset in accordance with the present disclosure.

The asset record 400 includes multiple fields 402 to 436. These fields are described below.

ID field 402 is an identification number of the failure mode (for example, from 001 to 999). The identification number allows sorting failure modes according to different criteria. In the asset record 400, the value of ID field 402 is 294.

Location field 404 represents a system to which the asset is considered to belong. In the asset record 400, the asset belongs to “Secondary Treatment-(B) Plant—Aeration Tank Set B1”.

TAG field 406 represents a reference of the asset. In the asset record 400, the reference of the asset is GLGWWTP.081701.

Equipment field 408 represents a short description of the asset. In the asset record 400, the asset is described as an Analyser Dissolved Oxygen Zone 3 Tank B1.

Category field 410 represents a category of the asset. In the asset record 400, the asset is categorised into Dissolved Oxygen Instrumentation.

Failure mode field 412 represents a mode of the failure. In the asset record 400, the failure mode is function lost. For most assets, one failure mode is considered: function lost. When necessary, more than failure modes can be considered for one asset. For example, three failure modes considered for a pump may include: function lost-usual (gland), severe (bearing), and efficiency decrease. Multiple failure modes can also be used when relevant (e.g., function loss of two pumps out of three).

Impacts field 414 represents impacts of the failure mode in terms of environment, safety, production, troubleshooting, and reputation costs. In the asset record 400, the impact of the failure mode includes a 10% increase in energy consumption.

MTBF field 416 represents a mean time between failure modes, in years. It can be calculated from history data extracted from the SCADA system 103 or the CMMS 105. The value of the MTBF field 414 may also be determined from the answers by Operation & Maintenance (O&M) staff representatives to one or more of the following questions: “On average, this failure mode occurs every how many years?” or “Since you work with this asset, how many times did you face this failure mode”. As a result, the MTBF can be calculated from the answers to these questions. If a particular asset never failed, an assumption of [1.5×period of observation] can be used as an estimate. For example, if the asset has never failed over the past 10 years, then MTBF=10×1.5=15 years. Alternatively, the value of the MTBF from similar assets can be used as an estimate.

Particular attention should be paid to differentiate the MTBF associated with an individual asset from the MTBF associated with a group of assets. If the SCADA system 103 records in average 2 function lost events per year for a particular asset. the MTBF would be ½=0.5 year. On the other hand, if the SCADA system 103 records one function lost event per year for a group of the 3 similar pumps, then the MTBF of the asset in the group would be (½)×3=1.5 years.

Av duration field 418 represents the average duration (in hours) of the failure mode impact, from the beginning of the impact to its end. The value of Av duration field 418 refers to the actual average time required to address the occurrence of the failure mode, considering realistic conditions in terms of transport time, spare parts availability, etc. In the asset record 400, the value of Av duration field 418 is 24 hours.

CM labour field 420 represents the average number of man-hours required to address an occurrence of the failure mode. For example, 2 technicians for 4 hours=8 man-hours. The value of CM labour field 420 can be determined based on the man-hours recorded on troubleshooting schedules. In the asset record 400, the average number of man-hours required to address this failure mode is 4 man-hours.

Mtce labour cost field 422 represents labour cost (in dollars) for troubleshooting, which is calculated based on the value of CM labour field 420 and a man-hour rate. For example, the labour cost for troubleshooting is 4 h×$80/h=$320.

Mtce Parts & Contractors field 424 represents the average cost of spare parts and contractors required to address an occurrence of the failure mode. In some cases, an occurrence of the failure mode is an opportunity to trigger a major overhaul or a replacement of the asset. In this case, the renewal cost should not be considered to be entirely caused by the occurrence of the failure mode but only the part that is technically linked to the failure mode. The rest of the cost would have been spent anyway in a planned work. 50% of the renewal cost can be used as a rough estimate of the average cost of spare parts and contractors. In the asset record 400, the value of Mtce Parts & Contractors field 424 is $1,400.

Safety field 426 represents the impact level of the failure mode on safety of the technician, which is calculated based on the CM labour. In the asset record 400, the safety cost is $40.

Production field 428 represents the impact level on production, for example, the costs in relation to untreated water, energy, reagents, cleaning. The value of production field 428 is determined based on, among other elements, flow, impact duration (e.g. duration of the impact/effect of maintenance activity), energy or reagents consumption. For example, 10% of energy over consumption for 24 hours=10%×$120/h×24 h=$288.

Environment field 430 represent the impact level on environment, there may be the four levels: no impact ($0), minor ($5k), serious ($30k), major ($100k).

Variable severity field 432 represents part of the failure mode impact severity that depends on time (impact duration), expressed in dollars/hour. The Var severity field 432 corresponds to the sum of impact levels on production and environment divided by the impact duration. If a failure mode has a variable severity, this means that each hour lost for troubleshooting the failure mode causes a cost to the organization. The variable severity is a useful indicator for troubleshooting prioritization and for low turnover spare parts decisions. On the other hand, fix severity is independent from time (impact duration). For example, the troubleshooting cost would be the same whether the troubleshooting activity is conducted after one hour or after one week. In the asset record 400, the value of variable severity field 432 is 12 $/h.

Criticality field 434 represents the first operation risk level (predetermined threshold) of the asset (i.e., indicating the value of the first parameter/value of a risk to failure R). As described above, the value of the criticality field 434 can be determined as follows: [Criticality]=([Mtce labour]+[Mtce parts & contractors]+[safety]+[environment ]+[production])/[MTBF]. In the asset record 400, the value of criticality field 434 is 2048 ($/year).

Criticality rank field 436 represents the operation criticality rank (relevance level) of the failure mode. As described above, the value of the criticality rank 436 may be determined based on the value of criticality field 434 and starts with one as the highest criticality rank.

As described above, the method 200 may determine the first operation risk level (predetermined threshold) of an asset (that indicates the value of the first parameter/value of a risk to failure R) according to an asset record associated with the asset.

In other examples, the SCADA system 103 determines first data (e.g. a risk to failure (RF)) indicative of the first operation risk level (predetermined threshold) of the asset (i.e., the value of the first parameter/value of a risk to failure R), and sends the first data (risk to failure (RF)) to the maintenance scheduling server 101 over the communication network 109. In some examples, the maintenance scheduling server receives the risk to failure (RF), and instructs the parameter calibration database 107 to update the value of criticality field 434 in the asset record associated with the asset. This may include the maintenance scheduling server 101 receiving the first data, and searching the parameter calibration database 107 for the asset record associated with the asset. If the asset record is found in the parameter calibration database 107, the maintenance scheduling server 101 stores in the criticality field 434 of the asset record the first operation risk level of the asset (i.e., the value of the first parameter R) based on the first data, or updates the value of criticality field 434 of the asset record with the first operation risk level of the asset (i.e., the value of the first parameter R) based on the first data.

Further, the operator of the asset may enter second data indicative of the properties of the maintenance activity conducted on the asset from a user interface (for example, a graphic user interface) associated with the maintenance scheduling server 101. In some examples, the maintenance scheduling server 101 receives the second data through the user interface, and instructs the parameter calibration database 107 to update one or more of the values of the set of parameters that correspond to the fields in the asset record associated with the asset. This may include the maintenance scheduling server 101 receiving the second data through the user interface, and searching the parameter calibration database 107 for the asset record associated with the asset. If the asset record is found in the parameter calibration database 107, the maintenance scheduling server 101 stores in the corresponding fields of the asset record the properties of the maintenance activity (i.e., values of the set of the parameters) based on the second data. The maintenance scheduling server 101 may also update the properties of the maintenance activity (i.e., values of the set of the parameters) in the corresponding fields of the asset record based on the second data.

The method 200 and other method steps described in the present disclosure may be implemented as a computer software program that is stored in a machine-readable medium. The machine-readable medium may be a memory device included in a computer system having a processor. The computer software program includes machine-readable instructions. When executed by the processor, these instructions causes the processor to perform the method 200 and other method steps described in the present disclosure.

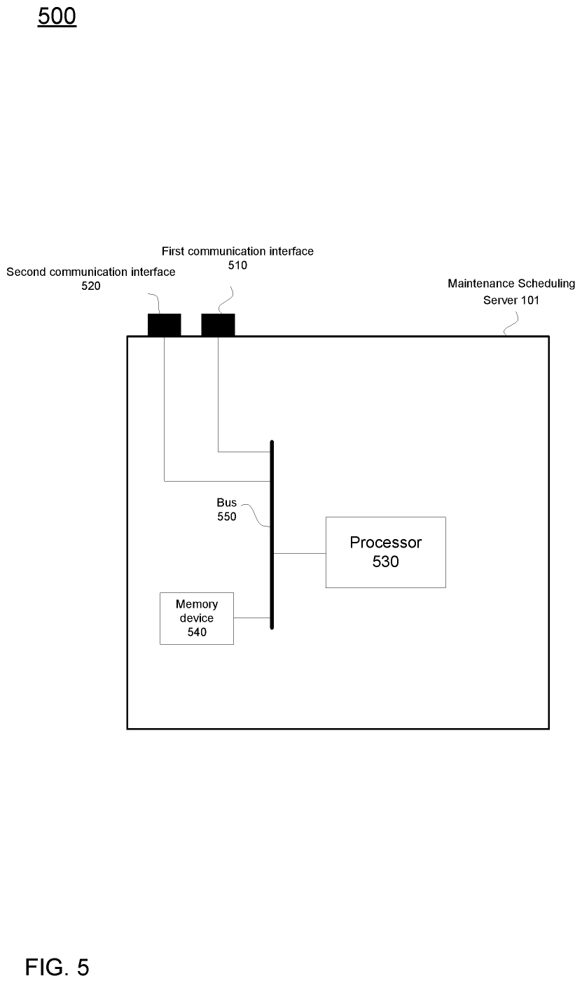

FIG. 5 illustrates an example computer system 500 for conducting a maintenance activity on an asset in accordance with the present disclosure. The computer system 500 represents an example structure of the maintenance scheduling server 101 described above.

The computer system 500 includes a first communication interface 510, a second communication interface 520, a processor 530, and a memory device 540. The computer 500 further includes a bus 550 that connects the first communication interface 510, the second communication interface 520, the processor 530, and the memory device 540.

The first communication interface 510 is configured to interface with the SCADA system 103. The second communication interface 520 is configured to interface with the parameter calibration database 107. It should be noted that although the first communication interface 510 and the second communication interface 520 are shown as separate interfaces, the first communication interface 510 and the second communication interface 520 can be implemented by a single communication interface that is able to be configured in different ways.

The memory device 540 is configured to store instructions. These instructions are implemented as machine-readable instructions included in a computer software program such as the one described above. When executed by the processor 530, these instructions cause the processor 530 to perform the method 200 as described above. A graphic user interface may also be stored in the memory device 540 for the operator to interact with the maintenance scheduling server 101, for example, entering the second data, as described above.

The processor 530 receives the instructions from the memory device 540 and is configured to
obtain a value of a first parameter (e.g. value of a risk to failure) from the SCADA system 103, via the first communication interface 510, the value of the first parameter (value of a risk to failure) being indicative of a first operation risk level (e.g. a predetermined threshold) of the asset over time with respect to a failure mode of the asset without a first conduct of the maintenance activity;
obtain values of a set of parameters from the parameter calibration database 107, via the second communication interface 520, the values of the set of parameters indicative of properties of the maintenance activity with respect to the failure mode of the asset; and
determine a time interval between the first conduct of the maintenance activity and a second conduct of the maintenance activity (e.g. action (A) activity) based on a model, the model containing the value of the first parameter (e.g. value of a risk to failure) and the values of the set of parameters and the model representing a value of a second parameter (e.g. new risk to failure (NRF)) indicative of a second operation risk level of the asset over the time interval (e.g. a period of time between actions (PA)) with respect to the failure mode of the asset given the first conduct of the maintenance activity and the second conduct of the maintenance activity (e.g. action (A) activity); and
if the average operation risk level indicated by the value of the second parameter (e.g. new risk to failure (NRF)) is lower than the first operation risk level (e.g. predetermined threshold) indicated by the value of the first parameter (e.g. value of a risk to failure), cause the second conduct of the maintenance activity (e.g. action (A) activity) to be performed.

The processor 530 is further configured to determine the time interval (e.g. a period of time between actions (PA)) such that the value of the second parameter (e.g. new risk to failure (NRF)) is minimised.

The computer system 500 may further include a third communication interface (not shown in FIG. 5) configured to interface with the CMMS 105, and the processor 530 is further configured to
send the time interval (e.g. the period of time between actions (PA)) to the CMMS 105, via the third communication interface, to cause the second conduct of the maintenance activity (e.g. action (A) activity) to be performed at the time interval (period of time between actions (PA)) after the first conduct of the maintenance activity is performed.

It should also be understood that, unless specifically stated otherwise as apparent from the following discussion, it is appreciated that throughout the description, discussions utilizing terms such as “obtaining” or “determining” or “sending” or “receiving” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

1. A computer-implemented method for conducting a maintenance activity on an asset, comprising:
obtaining a value of a first parameter, the value of the first parameter being indicative of a first operation risk level of the asset over time with respect to a failure mode of the asset without a first conduct of the maintenance activity;
obtaining values of a set of parameters indicative of properties of the maintenance activity with respect to the failure mode of the asset;
determining a time interval between the first conduct of the maintenance activity and a second conduct of the maintenance activity based on a model, the model containing the value of the first parameter and the values of the set of parameters, and the model representing a value of a second parameter indicative of an average operation risk level of the asset over the time interval with respect to the failure mode of the asset given the first conduct of the maintenance activity and the second conduct of the maintenance activity; and
if the average operation risk level indicated by the value of the second parameter is lower than the first operation risk level indicated by the value of the first parameter, causing the second conduct of the maintenance activity to be performed.

2. The computer-implemented method according to claim 1, wherein determining the time interval further comprises determining the time interval such that the value of the second parameter is minimised.

3. The computer-implemented method according to claim 1, wherein causing the second conduct of the maintenance activity to be performed comprising:
sending the time interval to a Computerized Maintenance Management System (CMMS) to cause the second conduct of the maintenance activity to be performed at the time interval after the first conduct of the maintenance activity is performed.

4. The computer-implemented method according to claim 1, causing the second conduct of the maintenance activity to be performed comprising:
generating a maintenance schedule containing the time interval; and
send the maintenance schedule to a maintenance mechanism associated with the asset, wherein the maintenance mechanism is configured to automatically perform the maintenance activity based on the maintenance schedule.

5. The computer-implemented method according to claim 4, further comprising:
sending a maintenance notification message including the maintenance schedule to a mobile device, the maintenance notification message causing the maintenance schedule to be displayed on the mobile device.

6. The computer-implemented method according to claim 1, wherein obtaining the values of the set of parameters comprises determining the values of the set of the parameters indicative of one or more of the following properties of the maintenance activity:
a level of an effect of the maintenance activity on the first operation risk level;
a duration of the maintenance activity;
a cost level of the maintenance activity; and
a fading mode of the effect of the maintenance activity on the first operation risk level.

7. The computer-implemented method according to claim 1, wherein obtaining the value of the first parameter comprises determining a failure frequency of the failure mode and a severity level of the failure mode to determine the value of the first parameter.

8. The computer-implemented method according to claim 7, wherein determining the failure frequency of the failure mode comprises determining an average failure frequency based on occurrences of the failure mode in a past period of time.

9. The computer-implemented method according to claim 8, wherein determining the severity level of the failure mode comprises determining the severity level based on impact levels indicative of impacts of the failure mode on one or more of following aspects:
production, troubleshooting, safety, environment, and reputation.

10. The computer-implemented method according to claim 9, wherein determining the severity level of the failure mode comprises calculating a sum of the impact levels.

11.-16. (canceled)

17. A computer-implemented method for conducting a maintenance activity on an asset, comprising the steps of:
a first step of obtaining input parameters, the input parameters being at least
a value of a risk to failure (R) over time t;
a value of a reduction of risk (RR) over time t, the reduction of risk being result of the implementation of an action (A);
a period of time (P) in which the value of the reduction of risk (RR) is maintained result of the implementation of the action (A);
a second step of determining a period of time between actions (PA) in such a way that a new risk to failure (NRF) over time is minimized, the new risk to failure (NRF) taking into account the input parameters, the time t and a cost (C) of performing the action (A).

18. A computer-implemented method according to claim 17 wherein the input parameters further comprise a value of the cost (C) of implementing the action (A).

19. A computer-implemented method according to claim 17 further comprising
a third step of calculating the (G) gain associated with implementing the action (A) and
a fourth step of discriminating whether the action (A) is to be implemented as a function of a comparison between the gain (G) with a predetermined threshold.

20. A computer-implemented method according to claim 17 wherein obtaining in a value of a risk to failure (R) over time t comprises determining a failure frequency based on occurrences of failure in a past period of time.

21. A computer-implemented method according to claims 17 wherein a decrease of value of a reduction of risk (RR) over time t, indicates a reduction in troubleshooting and/or safety and/or environment and/or reputation.

22. A computer-implemented method according to claim 17, further comprising determining a relevance level based on the value of the value of a risk to failure.

23. A computer-implemented method according to claim 17, wherein:
the step of obtaining a value of a risk to failure (R) over time t comprises receiving the value of a risk to failure (R) from a Supervisory Control and Data Acquisition, or SCADA system;
the step of obtaining a value of a reduction of risk (RR) over time t comprises receiving the value of a reduction of risk (RR) from a user interface;
the step of obtaining a period of time (P) in which the value of the reduction of risk (RR) is maintained result of the implementation of the action (A) comprises receiving the period of time (P) from a user interface.

24. A computer-implemented method according to claim 17, wherein the steps are periodically implemented and the values of the input parameters are updated at each implementation.

25. A computer software program, including machine-readable instructions which, when executed by a processor, causes the processor to perform steps comprising:
a first step of obtaining input parameters, the input parameters being at least
a value of a risk to failure (R) over time t;
a value of a reduction of risk (RR) over time t, the reduction of risk being result of the implementation of an action (A);
a period of time (P) in which the value of the reduction of risk (RR) is maintained result of the implementation of the action (A);
a second step of determining a period of time between actions (PA) in such a way that a new risk to failure (NRF) over time is minimized, the new risk to failure (NRF) taking into account the input parameters, the time t and a cost (C) of performing the action (A).

26. A computer system for conducting a maintenance activity on an asset, the computer system comprising:
means for obtaining a value of a risk to failure (R) over time t;
means for obtaining a value of a reduction of risk (RR) over time t, the reduction of risk being result of the implementation of an action (A);
means for obtaining a period of time (P);
means for determining a period of time between actions (PA) in such a way that a new risk to failure (NRF) over time is minimized, the new risk to failure (NRF) taking into account the input parameters, the time t and a cost (C) of performing the action (A).
